(19) United States
(12) Patent Application Publication
(10) Pub. No.: US 2019/0072174 A1
(43) Pub. Date: Mar. 7, 2019

(54) SIDE-ASSEMBLY-TYPE TRANSMISSION MOUNT

(71) Applicants: HYUNDAI MOTOR COMPANY, Seoul (KR); KIA MOTORS CORPORATION, Seoul (KR)

(72) Inventor: Seung-Won Kim, Seoul (KR)

(73) Assignees: HYUNDAI MOTOR COMPANY, Seoul (KR); KIA MOTORS CORPORATION, Seoul (KR)

(21) Appl. No.: 15/840,985

(22) Filed: Dec. 13, 2017

(30) Foreign Application Priority Data
Sep. 5, 2017 (KR) 10-2017-0113031

(51) Int. Cl. F16H 57/025; F16H 57/028

(52) U.S. Cl. CPC F16H 57/025; F16H 57/028

(57) ABSTRACT

Disclosed is a side-assembly-type transmission mount, in which a powertrain-rotation-preventing unit is mounted to a case, which is coupled to the upper portion of a transmission bracket, thereby preventing a powertrain from falling when a bolt is fractured. The powertrain-rotation-preventing unit includes a rotation-preventing pipe configured to allow the bolt to be inserted therethrough and to have rotation-preventing protrusions protruding from the upper and lower portions thereof, first rotation-preventing recesses formed in a core so as to have shapes corresponding to the rotation-preventing protrusions on the rotation-preventing pipe, and second rotation-preventing recesses formed in a space formed in a transmission support bracket. The rotation-preventing protrusions on the rotation-preventing pipe are inserted into the first and second rotation-preventing recesses formed in the core and the transmission support bracket.

### CROSS-REFERENCE TO RELATED APPLICATION

This application claims priority to and benefit of Korean Patent Application No. 10-2017-0113031, filed on Sep. 5, 2017 with the Korean Intellectual Property Office, the disclosure of which is incorporated herein by reference.

### BACKGROUND

### 1. Technical Field

The present disclosure relates to a side-assembly-type transmission mount, and more particularly, to a side-assembly-type transmission mount, in which a powertrain-rotation-preventing unit is mounted to a case, which is coupled to the upper portion of a transmission bracket, thereby preventing the powertrain from falling when a bolt is fractured.

### 2. Description of the Related Art

Recently, with the development of vehicle-related technologies and increased consumer demand for low vibration and low noise, many efforts have been made to maximize ride comfort by analyzing noise, vibration and harshness (“NVH”) that occur in a vehicle.

While a vehicle travels, vibration that occurs in a specific engine RPM range is transferred to the interior of the vehicle at a specific frequency via the vehicle body. At this time, the effect of engine combustion force on the vehicle interior is significant.

A vehicle transmission is a device that transmits engine power to the driving wheels while changing the torque and the speed in accordance with the traveling state of the vehicle. The transmission is directly connected to a crankshaft of the engine by a clutch.

The transmission produces a large amount of vibration and noise due to the mechanical operation thereof corresponding to the operation of the engine.

Therefore, in order to minimize the transfer of vibration and noise generated by the engine and the transmission to the vehicle body, and to improve passengers' ride comfort, the transmission is installed to the vehicle body frame using a transmission mount.

Because a powertrain (hereinafter, referred to as a “PT”), which includes a transmission typically weighing several hundred kilograms, is supported by three or four mounts, the mounts need to have high durability and robustness in the event of a collision. Even when a large load is applied to the transmission mount, for example, when the PT is pushed backward due to collision of the vehicle, the transmission mount needs to support the transmission without damage to a bracket, an insulator or an inner core of the transmission mount.

The reason for this is that deformation of a dash panel and pedals may occur if the PT is pushed backward, resulting in injury to the knees or ankles of passengers.

The transmission mount has a side-assembly structure such that the transmission mount connects the PT to the vehicle body in the lateral direction. The reason for assembling the above components in the lateral direction is that it is not possible for a worker to perform assembly above the vehicle body during the PT decking (mounting) process (the process of connecting the PT to the vehicle body) in a manufacturing line. Therefore, the worker performs the assembly process beside the vehicle body.

Because it takes a substantial investment (50 billion won or more) to modify a manufacturing line so that a worker is capable of performing the assembly process above the vehicle body, two long bolts are used for the PT decking process and are fastened in the lateral direction in order to avoid modification of the manufacturing line.

In a conventional vehicle, it is common to use one bolt to connect a bush and a bracket to each other.

In an example, as shown in FIG. 1A, one bolt 11 is used for an insulator 10. However, as shown in FIG. 1B, two bolts 60 are used for a transmission mount TM. The reason for using two bolts is that the bolts are subject to load in the shear direction and accordingly the fracture stress is reduced in comparison with the axial direction. Further, in order to prevent the PT from falling due to bolt fracture, a safer design employing two bolts is being used in vehicles. However, this design has a shortcoming in that manufacturing costs and weight (one bolt weighs about 0.25 kg) are increased, the size of a core is increased due to the application of two bolts, and the amount of rubber of the stopper is reduced due to the increase in the size of the core. The reduction in the amount of rubber of the stopper leads to deterioration of NVH characteristics, ride and handling (R&H) performance and durability.

In addition, installation of a according to conventional methods is inconvenient in that the worker needs to stand on a work platform and to perform the installation of the engine and the transmission mount at the same time on the work platform.

In order to mount the engine and the transmission mount to the vehicle body, the worker fastens bolts in the downward direction from a high position (i.e. on the work platform), which entails the likelihood of a falling accident or the like. In some cases, the engine assembly process is not completed within a required time limit, and accordingly the manufacturing line needs to be reconfigured.

In order to solve the above problem, the present applicant developed a “SIDE-ASSEMBLY-TYPE TRANSMISSION MOUNT” (Korean Patent Registration No. 10-1244708).

As shown in FIG. 2, the transmission mount disclosed in the above patent document includes a cylindrical insulator 10; a core 21; which is inserted into insulator 10 and has a plurality of holes formed therethrough in the longitudinal direction and an inner space 22 cut in the width direction; a plate stopper 40, which is fitted in inner space 22 in core 21; a cylindrical case 50 accommodating core 21 and insulator 10, a plurality of bolts 60, each of which is longer than case 50 and is inserted through a corresponding one of the holes in core 21 and plate stopper 40 from a side so as to protrude outside case 50; and a transmission support bracket 70, which has an upper portion directly coupled to protruding bolts 60 and a lower portion coupled to the transmission. Core 21 is longer than case 50 enveloping insulator 10 and is inserted into insulator 10 in an integral manner so as to protrude outside case 50 and so as to be directly connected to the side surface of transmission support bracket 70 by bolts 60.

However, in the side-assembly-type transmission mount having the above-described construction, as shown in FIG. 3A, because threads are formed at the portions of bolts that are fastened to transmission support bracket 70, there is a high risk that the threaded portions of the bolts will be fractured due to damage to notched portions thereof.

For example, as shown in FIG. 3B, each of the bolts 60 is fastened in a manner such that the middle portion thereof is not in contact with (i.e. is spaced apart from) the inner circumference of a support hole 82 formed in support 80 and a through-hole 23 formed in core 21, and, as a result, the tip portion thereof may be subject to strong shear force.

For example, because currently-used bolts 60 are quite long (about 161 mm) and are spaced about 0.2 mm apart from the inner circumference of through-hole 23, the shear force applied to two opposite ends of the moment arm is high, resulting in the notched portions of the bolt being damaged or the bolt being easily released.

### RELATED ART DOCUMENTS

1. Korean Patent Registration No. 10-1244708 (Mar. 12, 2013)

2. Korean Patent Registration No. 10-1746576 (Jun. 7, 2017)

3. Korean Patent Laid-open Publication No. 10-2013-0030945 (Mar. 28, 2013)

4. Korean Patent Laid-open Publication No. 10-2005-0053284 (Jun. 8, 2005)

### SUMMARY OF THE DISCLOSURE

The present disclosure addresses the above problems by providing a side-assembly-type transmission mount having a simplified bolt-fastening structure such that the number of bolts is reduced from two to one, thereby increasing the amount of stopper rubber, increasing the degree of design freedom, and improving NVH characteristics and R&H performance.

It is another object of the present disclosure to provide a side-assembly-type transmission mount, in which a powertrain-rotation-preventing unit is mounted to a case, which is coupled to the upper portion of a transmission bracket, thereby preventing the powertrain from falling when a bolt is fractured.

The technical objects to be achieved by the present disclosure are not limited to those mentioned above, and other objects may be clearly understood by those skilled in the art from the description given below.

In accordance with the present disclosure, the above and other objects can be accomplished by the provision of a side-assembly-type transmission mount comprising a core inserted into an insulator and having a through-hole formed therethrough in the longitudinal direction; a plate stopper coupled to the core; a cylindrical case accommodating the core and the insulator; a bolt formed to be longer than the case and to be inserted through holes formed in the core and the plate stopper from a side so as to protrude outside the case; a transmission support bracket having an upper portion directly coupled to the bolt protruding outside the case and a lower portion coupled to a transmission; a rotation-preventing cage and a rotation-preventing nut, mounted to the upper portion of the transmission support bracket to mesh with the bolt; and a powertrain-rotation-preventing unit mounted between the rotation-preventing cage and the core.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1A and 1B are views showing a conventional transmission mount FIG. 1A is a view showing a conventional transmission mount mounted to the engine using one bolt and FIG. 1B is a view showing a powertrain fixed using two bolts;

FIG. 2 is an exploded perspective view of a conventional transmission mount;

FIG. 3A is a sectional view of a conventional transmission mount;

FIG. 3B is a partially-enlarged sectional view showing a bolt-fastened region in a conventional transmission mount;

FIG. 4 is an exploded perspective view of a side-assembly-type transmission mount according an example embodiment of the present disclosure;

FIGS. 5A and 5B are views showing the side-assembly-type transmission mount according to and example embodiment of the disclosure, to which a rotation-preventing unit is mounted. FIG. 5A is a partially-sectional perspective view of the side-assembly-type transmission mount according to an example embodiment, and FIG. 5B is a partially-sectional perspective view showing a rotation-preventing nut and a rotation-preventing cage in an exploded state, which are mounted to a transmission support bracket;

FIGS. 6A and 6B are partial perspective views of a transmission support bracket according to an example embodiment of the present disclosure. FIG. 6A is a partial front perspective view of the transmission support bracket in the state in which the rotation-preventing nut and the rotation-preventing cage are coupled thereto and FIG. 6B is a partial rear perspective view thereof;

FIG. 6C is a perspective view of a rotation-preventing pipe, as used in an example embodiment described herein;

FIG. 7A is a perspective view schematically showing the state in which the rotation-preventing pipe is inserted through a core in an example embodiment as described herein; and

FIG. 7B is a sectional view showing the side-assembly-type transmission mount according to an example embodiment of the present disclosure, to which the rotation-preventing unit is mounted.

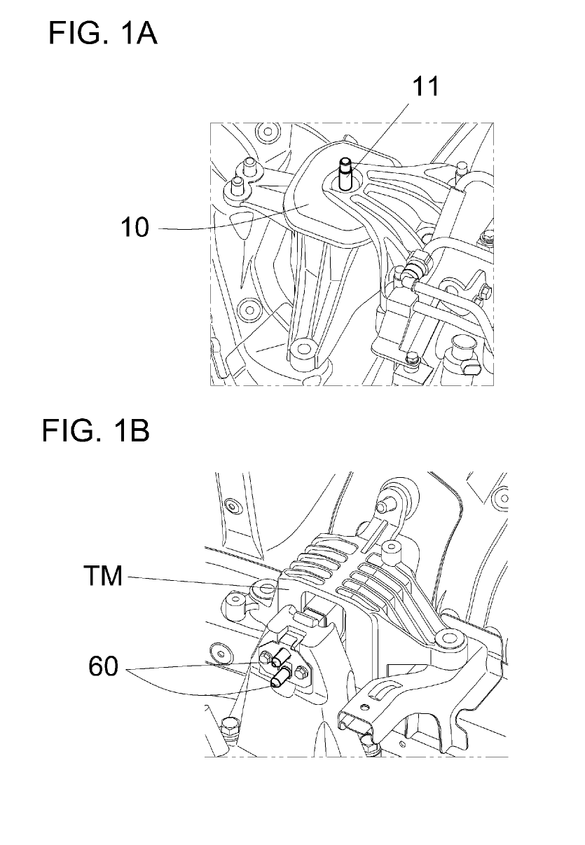

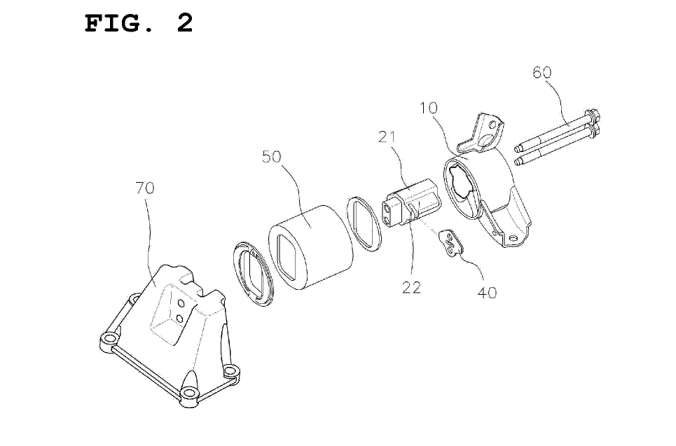

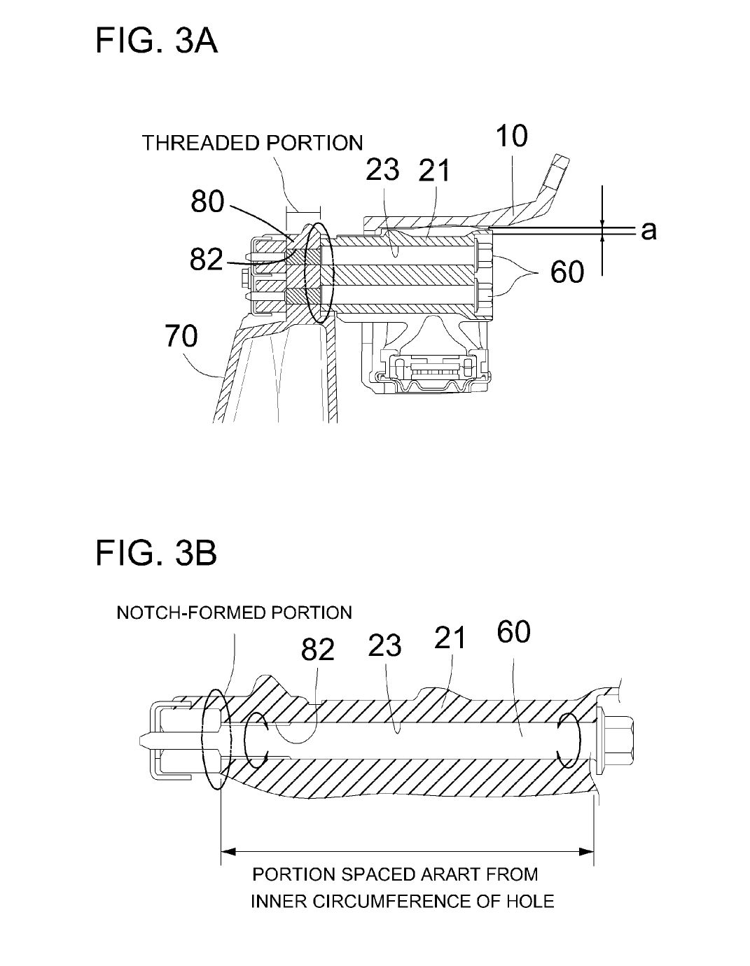

### DETAILED DESCRIPTION OF THE PREFERRED EMBODIMENTS

Reference will now be made in detail to the embodiments of the present disclosure, examples of which are illustrated in the accompanying drawings, to allow those skilled in the art to easily understand and reproduce these embodiments. However, the embodiments disclosed herein may be implemented in various different forms, and the disclosure is not limited to the embodiments described herein.

To clearly explain the present disclosure, the illustration of elements having no connection with the description is omitted, and the same or extremely similar elements are designated by the same reference numerals throughout the specification.

In addition, the terms or words used in the specification and claims of the present invention are not to be interpreted using typical or dictionary-limited meanings, and are to be construed as having meanings and concepts conforming to the technical spirit of the present invention based on the principle that the inventors can appropriately define the concepts of the terms to explain the present invention in the best manner.

Hereinafter, an example embodiment will be described in detail with reference to the accompanying drawings.

Further, the same reference numerals are used to designate the same elements as those in the prior art, and a detailed explanation thereof will be omitted.

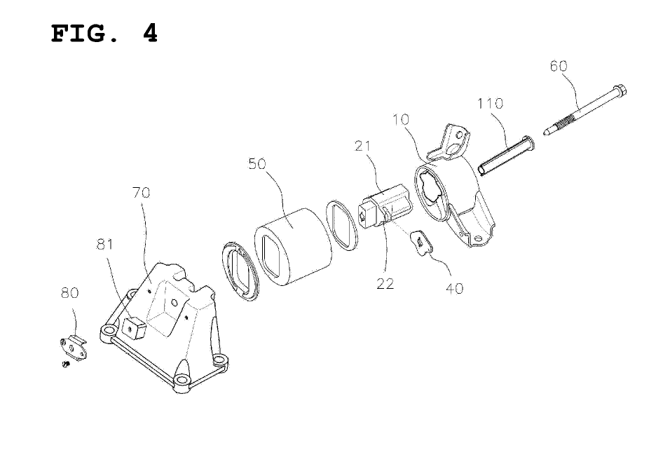

As shown in the example embodiment of FIG. 4, the side-assembly-type transmission mount includes a cylindrical insulator 10; a core 21, which is inserted into insulator 10 and has a through-hole 23 formed therethrough in the longitudinal direction; a plate stopper 40, which is coupled to core 21; a cylindrical case 50, which accommodates core 21 and insulator 10; a bolt 60, which is longer than case 50 and is inserted through the holes formed in core 21 and plate stopper 40 from a side so as to protrude outside case 50; a transmission support bracket 70, which has an upper portion directly coupled to protruding bolt 60 and a lower portion coupled to the transmission; and a rotation-preventing cage 80, which supports a rotation-preventing nut 81, which is mounted to the upper portion of transmission support bracket 70 and meshes with bolt 60.

As described above, the side-assembly-type transmission mount of the present disclosure is distinguished from the prior art in that the number of bolts is reduced from two to one and in that core 21 has a structure such that only one bolt is inserted therethrough.

In addition, the side-assembly-type transmission mount is characterized in that a powertrain-rotation-preventing unit 100 is mounted between rotation-preventing cage 80 and e core 21.

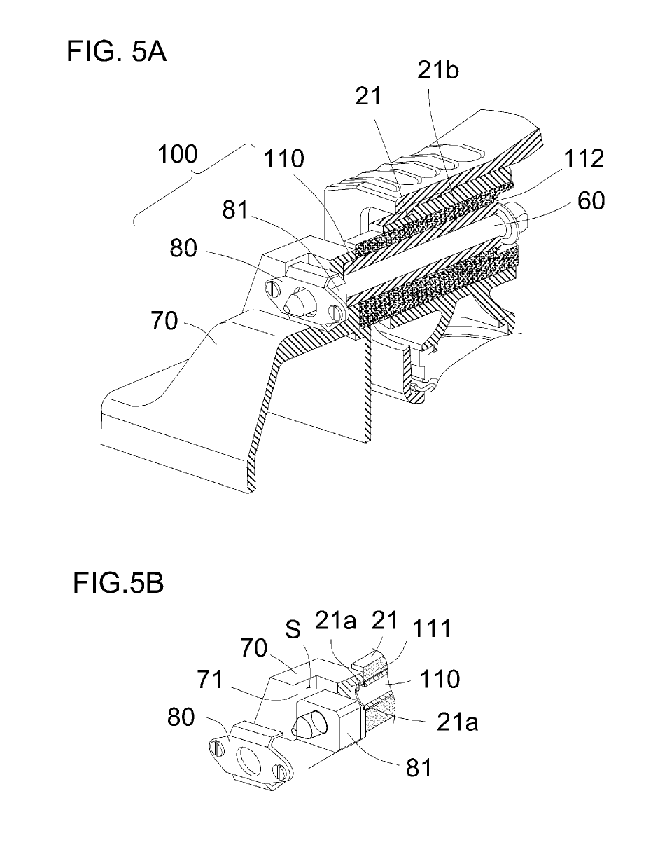

As shown in FIGS. 4 and 5, powertrain-rotation-preventing unit 100 includes a rotation-preventing pipe 110, through which bolt 60 is inserted and which has rotation-preventing protrusions 111 protruding from the upper and lower portions thereof; first rotation-preventing recesses 21a, which are formed in core 21 and have shapes corresponding to rotation-preventing protrusions 111 on rotation-preventing pipe 11;, and second rotation-preventing recesses 71, which are formed in a space S formed in transmission support bracket 70. Accordingly, rotation-preventing protrusions 111 on rotation-preventing pipe 110 are inserted into first and second rotation-preventing recesses 21a and 71, which are formed in core 21 and transmission support bracket 70.

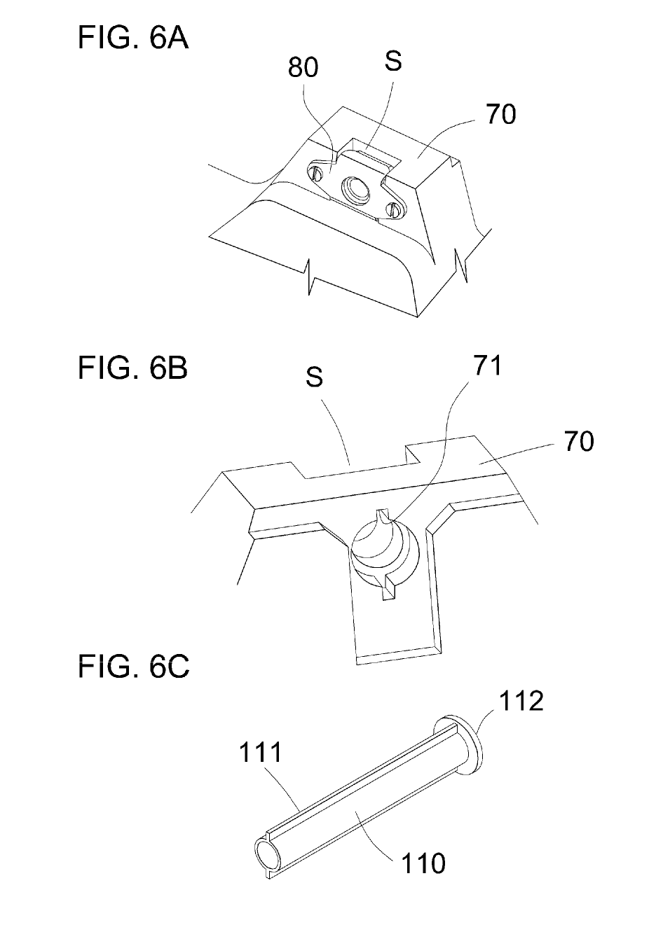

Described in more detail, rotation-preventing pipe 110, as shown in FIG. 6C, includes a flange 112 formed at an end thereof, through which bolt 60 enters. In a preferred embodiment, the body of rotation-preventing pipe 110 is a long cylindrical pipe. In a further preferred embodiment, the body is made of steel. Flange 112 serves as a stopper that stops the insertion movement of rotation-preventing pipe 110 into core 21 when rotation-preventing pipe 110 is completely inserted into core 21.

In addition, rotation-preventing protrusions 111 protrude from rotation-preventing pipe 110 and extend along the length of rotation-preventing pipe 110. Rotation-preventing protrusions 111 extend in a direction normal to the surface of the cylindrical body of rotation-preventing pipe 110.

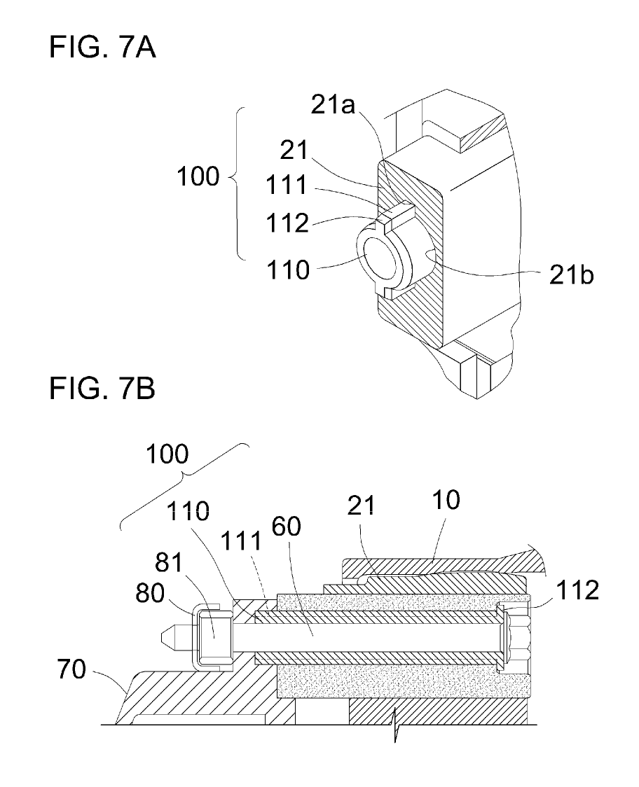

In addition, in an example embodiment as shown in FIG. 7A, rotation-preventing pipe 110 may also have a slanted surface 112 formed at a front end thereof so as to facilitate the assembly of rotation-preventing pipe 110 with transmission support bracket 70.

Transmission support bracket 70, into which rotation-preventing pipe 110 is fixedly inserted, is illustrated in example embodiments in FIGS. 6A and 6B.

FIG. 5A or FIG. 6A is a partial front perspective view of transmission support bracket 70 where rotation-preventing nut 81 and rotation-preventing cage 80 are coupled thereto, and FIG. 6B is a partial rear perspective view of transmission support bracket 70 where rotation-preventing nut 81 and rotation-preventing cage 80 are coupled thereto.

As shown in FIG. 6A, rotation-preventing nut 81 and rotation-preventing cage 80 are coupled to the upper portion of transmission support bracket 70 using screws, and the space S, in which rotation-preventing nut 81 is seated, is formed in the front upper portion of transmission support bracket 70.

In addition, as shown in FIG. 6B, second rotation-preventing recesses 71 are formed in the shape corresponding to rotation-preventing protrusions 111 formed on rotation-preventing pipe 110 so that rotation-preventing protrusions 111 on rotation-preventing pipe 110 are inserted into second rotation-preventing recesses 71.

As shown in the example embodiment of FIG. 5B, rotation-preventing nut 81 is embodied as a square nut, and the space S, which is formed in transmission support bracket 70 to receive rotation-preventing nut 81, is also configured in the square shape. This prevents bolt 60 from rotating after being fastened to rotation-preventing nut 81.

In addition, as shown in FIG. 7A, core 21, through which rotation-preventing pipe 110 is inserted, has therein first rotation-preventing recesses 21a formed in a shape corresponding to rotation-preventing protrusions 111 on rotation-preventing pipe 110.

Through-hole 21b and first rotation-preventing recesses 21a are formed in core 21 such that the dimensions thereof are equal to or slightly less than those of rotation-preventing protrusions 111 on rotation-preventing pipe 110 in order to achieve an interference fit, thereby preventing rotational movement of core 21 and transmission support bracket 70 and consequently preventing bolt 60 from being released. In addition, in a preferred embodiment, an end portion of through-hole 21b, through which bolt 60 enters, is formed such that bolt 60 is spaced about 8 to 10 mm apart therefrom, whereby a head portion of bolt 60 is inserted into the end portion of through-hole 21b by torque applied to the bolt.

When excessive torque is applied to bolt 60, core 21 may buckle, or the bolt-fastened surface of core 21 may be damaged. Therefore, in the prior art, core 21 is manufactured through a squeeze method using AC4CH-T6. However, this squeeze method is complicated and costly.

In order to solve this problem, in the present disclosure, manufacturing costs are reduced by reinforcing the bolt-fastened surface of the core 21 using a rotation-preventing pipe 110 made of steel without the need for the squeeze method. In a preferred embodiment, core 21 is made of aluminum.

As described above, transmission support bracket 70 prevents looseness of the front portion of bolt 6- and rotation-preventing pipe 110 prevents looseness of the rear portion of bolt 60. Further, because rotation-preventing pipe 110 is mounted between transmission support bracket 70 and core 21, it is possible to prevent these components from falling when the bolt is fractured and to prevent the components from being separated from each other in the forward and backward directions.

Furthermore, because the number of bolts 60 needed to support transmission mount 70 is reduced from two to one, thickness of the stopper is increased from about 3.5 mm to about 10.5 mm or more. By the thickness of the stopper is increased, leading to an increase in the degree of design freedom and improvement of NVH characteristics, R&H performance and durability.

As is apparent from the above description, a side-assembly-type transmission mount according to the present disclosure has the following beneficial effects.

First, because the transmission mount has a simplified bolt-fastening structure such that the number of bolts is reduced from two to one, it is possible to increase the amount of rubber of a stopper, to increase the degree of design freedom, and to improve NVH characteristics and R&H performance.

Second, the reduction in the sizes of a core and an insulator, through which the bolt is inserted, whereby the overall size of the transmission mount is reduced, which is advantageous from the aspect of package layout.

Third, the reduction in the number of bolts from two to one leads to improved productivity.

Fourth, it is possible to reduce the amount of shear force applied to the bolt by minimizing the portion of the bolt that is spaced apart from the inner circumference of holes formed in a core and a transmission support, thereby preventing the bolt from being fractured.

Fifth, it is possible to greatly reduce manufacturing costs by modifying the structure of the core so as to obviate the need for a conventional complicated and expensive manufacturing process.

Although preferred embodiments have been disclosed for illustrative purposes, those skilled in the art will appreciate that various modifications, additions and substitutions are possible, without departing from the scope and spirit of the invention as disclosed in the accompanying claims.

What is claimed is:

1. A side-assembly-type transmission mount comprising:
a core inserted into an insulator and having a through-hole formed therethrough;
a plate stopper coupled to the core, and having a though-hole;
a case accommodating the core and the insulator;
a bolt formed to be longer than the case and to be inserted through the through-hole formed in the core and the plate stopper from a side so as to protrude outside the case;
a transmission support bracket having an upper portion directly coupled to the bolt protruding outside the case and a lower portion coupled to a transmission;
a rotation-preventing cage and a rotation-preventing nut, mounted to the upper portion of the transmission support bracket to mesh with the bolt; and
a powertrain-rotation-preventing unit mounted between the rotation-preventing cage and the core.

2. The side-assembly-type transmission mount according to claim 1, wherein the powertrain-rotation-preventing unit comprises:
a rotation-preventing pipe configured to allow the bolt to be inserted therethrough and to have rotation-preventing protrusions protruding therefrom;
first rotation-preventing recesses formed in the core having shapes corresponding to the shape of the rotation-preventing protrusions on the rotation-preventing pipe; and
second rotation-preventing recesses formed in a space formed in the transmission support bracket.

3. The side-assembly-type transmission mount according to claim 2, wherein the rotation-preventing pipe is inserted through the core in an interference-fit manner and is coupled to the transmission support bracket in a sliding manner.

4. The side-assembly-type transmission mount according to claim 2, wherein the rotation-preventing pipe further comprises a slanted surface formed at an end thereof so as to facilitate assembly of the rotation-preventing pipe with the transmission support bracket.

5. The side-assembly-type transmission mount according to claim 1, wherein the rotation-preventing nut is a square nut, and the transmission support bracket has therein a space formed to receive the rotation-preventing nut, the space being formed in a square shape.

6. The side-assembly-type transmission mount according to claim 1, wherein the case is cylindrical.

7. The side-assembly-type transmission mount according to claim one wherein the through-hole in the core extends in a longitudinal direction.

8. The side-assembly-type transmission mount according to claim 2, wherein the rotation-preventing protrusions on the rotation-preventing pipe are inserted into the first and second rotation-preventing recesses formed in the core and the transmission support bracket.
